(19) United States
(12) Patent Application Publication
(10) Pub. No.: US 2026/0287071 A1
(43) Pub. Date: Sep. 24, 2026

(54) TIGHT SPRING CAVITY WITH FILLER

(71) Applicant: FloWorks International LLC, Houston, TX (US)

(72) Inventor: Jason WALKER, Houston, TX (US)

(73) Assignee: FloWorks International LLC, Houston, TX (US)

(21) Appl. No.: 19/554,098

(22) Filed: Mar. 2, 2026

Related U.S. Application Data
(60) Provisional application No. 63/766,956, filed on Mar. 4, 2025.
(60) Provisional application No. 63/951,778, filed on Dec. 31, 2025.

(51) Int. Cl. F16K 5/20

(52) U.S. Cl. CPC F16K 5/201

(57) ABSTRACT

A ball valve, especially coker ball valves, wherein the spring cavity with spring to bias the seat against the ball does not have empty space, but instead a porous filler is added thereto to largely fill the space. The filler serves to reduce empty space, minimizing process fluid entry, but higher pressure purge fluid can still pass therethrough. This design greatly expands the lifespan of these components. Other features that can be included with the filler, or employed separately or in various combinations thereof include 1) a unitary spring-liner-and-ball seat component, 2) a second seat distal to the ball seat and 3) a redesigned ball seat with groove or ledge at or near the hole side of the curving seat face and steam tunnels or holes through the seat and exiting in the groove or ledge allowing steam or other purge fluid to be directed to the seat/ball interface.

### PRIOR RELATED APPLICATIONS

This application claims priority to U.S. Ser. No. 63/951,778, filed Dec. 31, 20205, and to 63/766,956, filed Mar. 4, 2025, each incorporated by reference in its entirety for all purposes.

### FIELD OF THE DISCLOSURE

The disclosure generally relates to ball valve configurations wherein the spring used to hold the seat tightly against the ball is filled or surrounded with filler, thus reducing the tendency of process fluids to enter into this space, and thereby significantly prolonging the life of the valve and its components.

### BACKGROUND OF THE DISCLOSURE

Petroleum refining operations where crude oil is processed frequently produces residual oils that have very little value. The value of residual oils can be increased, however, by processing in a delayed coker unit (“DCU”). In the DCU residual oil is heated to a temperature sufficient to cause destructive distillation whereby a substantial portion of the residual oil is converted or “cracked” to usable hydrocarbon products. The remainder is a residual petroleum by-product called “coke,” a material composed mostly of carbon that has a variety of industrial uses.

The delayed coker process is a batch process, and is one of the most hostile environments in the refinery due to the abrasive and erosive properties of the coke by-product. The name “delayed” arises because the cracking process continues even after leaving the furnace to reside in the coke drums, being delayed by the use of water and short residence times in the furnace.

The coking batch process requires frequent use of switch and/or isolation valves during the coke drum switching operation-one drum being operational to make coke while the other is cooled and de-coked. Specialty valves allow personnel to safely unhead a cooled drum while another drum is ‘live’. If the valves do not positively isolate the hot coker drum, product could leak into the off-line drum creating a significant safety hazard.

Coker valves are the specialized valves used in the delayed coking process. Common types include coking isolation valves, switching valves, and safety relief valves, each designed to handle the harsh conditions and thermal cycling associated with coking processes. The most common type of valve design is a ball valve, but lifting plug and sliding gate valves are also available. This application specifically discusses ball valves, but aspects herein, such as spring cavity fillers, may be applicable to other valve types.

The ball valve is a shut-off valve that uses a rotating ball with a straight or bent hole or tunnel therethrough to control the flow of gases and liquids. When the tunnel in the ball is in-line, it allows flow, whereas when rotated 90 degrees, the solid part of the ball prevents flow.

There are two ways of mounting the ball in a ball valve-floating and trunnion mounted. In addition, there are varying ball and body configurations including 3-way (bent tunnel), top entry, side entry or split body and three-piece body. Typically, for coker valves the trunnion mounted valve is used, although butterfly/ball valves are also found.

Trunnion-mounted ball valve designs feature a “trunnion” at bottom of the ball. This plus the stem serve to anchor and support the ball in the valve. This design provides a positive seal on both downstream and upstream seats, regardless of pressure, allowing for double block and bleed, or double isolation and bleed function. This makes trunnion design ball valves suitable for larger-bore and higher-pressure operations. Additionally, this design reduces torque required to rotate the valve, making a trunnion design ideal for automated ball valve applications.

Most ball valves are quick-acting, requiring a 90° turn of the valve handle to operate the valve. But for large valves, which require considerable force to open or close the valve, a gear-operated actuator is used. With this arrangement, a small handwheel is enough to operate a fairly large valve. Modern units, however, use automatic control of the valve, the actuator being equipped with an on board processor.

A “bellows” (corrugated tube spring) or “Belleville spring” (washer shaped spring, with slight conical frustum) are forms of loading internal valve components (such as the seat against the ball in a ball valve) for the purpose of tight sealing and maintained preloads when valve is installed in high thermal cycling.

Although coking valves are designed to handle the harsh conditions in the refinery, coke buildup inside the valves is inevitable, and any buildup reduces internal tolerances and negatively impacts operations.

One place that easily allows process fluids to enter is the spring cavity holding the spring(s) that push the seat against the ball. The spring region is made with high tolerances to allow for the extreme expansion and contraction that occurs on temperature cycling between a hot active drum and the cooled drum undergoing de-coking. In this region, the push seat (aka ball seat) and the spring liner are two separate pieces, with space therebetween. Further, the spring itself has cavities or spaces that can allow deposition, and the spring cavity is not sealed at the end opposite the push seat. All of this means that steam injected into this space via purge inlets freely escapes into the process fluid and steam usage is much greater than needed, greatly increasing costs.

Another common place for process fluids to enter and allow coke deposition is the small space between the seat and ball, especially if any damage has occurred to either surface. Once galling or spalling occurs on either sealing surface, the valve quickly degrades due to coke particles, and the valve must be rebuilt or replaced.

Buildup is mitigated with purge valves. Purging is the process of removing coke buildup from valves by injecting steam or other available fluid into the valve to flush it. Purging ports are configured on the coking valves where buildup is likely, for example the spring cavity, the space between the ball and seat, the stem, and other critical components. Steam or another purge fluid is injected into the purging ports at high pressure, typically much higher than the operating pressure of the delayed coking process. This prevents process fluid from entering the inner workings of the valve, and/or if present sweeps it back out of the inner workings of the valve.

Conventionally, all purge ports that are attached to multiple coking valves are connected to the same steam source, and the steam is continuously supplied to exclude process fluids and prevent buildup. In this setting, large amounts of steam are consumed in the purging process, which contributes to the operational costs. Furthermore, the amount of steam is constant, and not capable of fine control to meet varying operational needs at individual purge ports.

Therefore, there is a need for improved design of the spring area that prevents spring cavity build up. There is also a need for a design that resists steam loss and coke build up. The ideal method or design can easily be retrofitted into existing ball valves, and does not necessitate complete replacement of the valve, although this is of course possible. This invention meets one or more of these needs.

### SUMMARY OF THE INVENTION

In this disclosure the spring cavity is protected by adding a filler to the spaces in the spring cavity, either along the inner and outer corrugations of a bellows spring, or adjacent a Belleville spring and/or between adjacent Belleville springs if more than one is used. The filler material is sufficiently porous to allow the high pressure purge fluid to pass therethrough, but resists the incursion of process fluid, which is always at lower pressure than the steam. With this single added element, the lifespan of the springs is at least doubled, and preferably extends life five-, ten- and potentially 15- or 20-fold or more.

Any porous material that can withstand the temperatures and chemical content of the process fluid may be used as the filler. In the coker context, as well as in many chemical plants, the ideal filler is a graphite material that is braided and is highly malleable and can withstand the temperatures and chemicals of the DCU.

We contemplate that “all” spaces in the spring cavity are filled, recognizing that perfection is unlikely. Nevertheless, by all spaces, we mean that a best attempt to fill all spaces is made. Filling these spaces will at least double the lifespan of a “control” valve that is the same as the test valve, except lacking the filler.

Suitable filler materials include GRAPHI-BRAID™ 1000 by GRAPHIMATERIALS™ which in vacuum can withstand 5400° F., in steam or mild oxidation up to 2000° F. and in air up to 850° F. Also available is 1625G by JOHN CRANE™ Our currently preferred material for coker valve use is FAB 5082 by FLEXAEAL™, a braided combination of expanded flexible graphite and INCONEL® wire.

INCONEL® is a superalloy composed mainly of nickel, chromium, and iron that is often used in extreme environments where components are subjected to high temperature, pressure, or mechanical loads. bIt is known for its excellent resistance to high temperatures, oxidation, and corrosion.

A few of the other fibers that can be used as filler include PTFE (TEFLON®), Carbon, Aramid (KEVLAR®), Flax, and GFO®, depending on what process fluid and temperatures are used.

In addition to filling the spaces in the spring with this filler, additional improvements to the spring cavity region are provided herein, and these may be used separately, or in any combinations thereof, but preferably are combined with the spring cavity filler, greatly increasing the lifespan of these components, as well as the ball valve overall.

In the prior art, the spring liner and the push or ball seat are two separate pieces. Herein, we combine these two into a single piece, thereby eliminating the flow path therebetween.

In addition, a second seal is added to the end of the spring opposite the ball seat, and a seal may also be included on the ball seat itself. This is preferably done by grooving the internal component and placing a seal in the groove. It is certainly possible to groove the valve body or even groove both components, but grooving the liner and/or ball seat is easier to manufacture and to retrofit.

With the filler, the unitary ball seat-and-liner preferably with seal and the second distal seal, the spring cavity is much more enclosed than in the prior art designs, minimizing the amount of steam escaping into the process fluids when the valve is open.

A final improvement is a redesign of the ball seat itself. In the prior art, the ball seat is a stout annular disk with the inner surface machined to perfectly fit against the ball, thus providing a seal when pressure from the spring is applied. As noted above, however, any imperfection in either metal surface will reduce the quality of the seal, allowing process fluid to enter and further degrade the valve interior.

We have modified the ball seat design by adding an annular groove on the ball side of the seat along or near the inner edge adjacent the hole, preferably somewhere intermediate or central between the two edges. We also provided steam entry holes from the backside of the seat to this groove. Thus, when assembled, steam will pressurize the ball/seat area and even with modest galling or spalling, process fluids will be kept out by the higher pressure steam.

The combined use of the spring cavity filler, unitary liner-and-ball seat, proximal and distal seals, and adaptive ball seat provide for extended reliability of the springs and ball seat components of the ball valve. These improvements may be each used alone, all combined, or in any combination(s) thereof.

The invention thus includes any one or more of the following embodiment(s) in any combination(s) thereof:
A ball valve comprising: a) a housing body having a flow path therethrough, said flow path containing a rotatable ball having a hole therethrough; b) said ball adjacent an annular ball seat, said ball seat having an annular curved surface interfacing with said ball and an annular spring-facing surface opposite said curved surface; c) an annular spring cavity adjacent said ball seat; d) one or more purge inlet(s) penetrating said housing body to said spring cavity; e) said spring cavity housing an annular spring for biasing said ball seat against said ball so as to provide a seal between said curved surface and said ball; and f) said spring cavity having a porous filler in space unoccupied by said spring.
A ball valve comprising: a) a housing body having a flow path therethrough, said flow path containing a rotatable ball having a hole therethrough; b) said ball adjacent a first annular ball seat, said ball seat having an annular curved surface interfacing with said ball to provide a seal and an annular spring-facing surface opposite said curved surface; c) an annular spring cavity adjacent said first ball seat; d) a second ball seat opposite said first ball seat; e) one or more purge inlet(s) penetrating said housing body to said spring cavity; f) said spring cavity housing an annular spring for biasing said ball seat against said ball so as to provide a seal between said curved surface and said ball; and g) said spring cavity having a porous filler in space unoccupied by said spring.
A coker ball valve, having one or more spring(s) in a spring cavity, said spring(s) configured to press a ball seat against a rotatable ball having a hole therethrough, and a braided graphite filler within said spring cavity surrounding said spring to reduce empty space within said spring cavity, said spring having at least twice the lifespan of a spring in a control coker ball valve lacking said filler.
A component of a ball valve, said component comprising: a) an integral spring-liner-and-ball-seat comprising a spring-liner portion and a ball-valve portion; b) said spring-liner portion configured for supporting a separate annular spring configured to press said ball-seat portion against a separate ball in a separate ball valve when assembled therewith; and c) said spring-liner portion having an annular groove on a spring cavity facing surface thereof, and a separate seal in said annular groove and adjacent a body of said separate ball valve when assembled therewith.
A component of a ball valve, said component comprising: a) an integral spring-liner-and-ball-seat comprising a spring-liner portion and a ball-valve portion; b) said spring-liner portion configured for supporting a separate annular spring configured to press said ball-seat portion against a separate ball in a separate ball valve when assembled therewith; and c) said spring-liner portion having an annular groove on a spring cavity facing surface thereof, and a separate seal in said annular groove and adjacent a body of said separate ball valve when assembled therewith; d) said ball-seat portion having an annular curved surface interfacing with said separate ball and an annular spring-facing surface opposite said curved surface; e) wherein said ball-seat portion further comprises an annular groove in said curved surface, and holes penetrating said ball-seat portion from said spring-facing surface to said groove, such that a purge fluid can travel through said holes to reach an interface between said curved surface and said separate ball when said component is assembled therewith to make a ball valve with purge inlets; and f) said ball-seat portion further comprising an annular groove on an outer diameter surface and a separate seal in said groove and adjacent said body of said separate ball valve when assembled therewith.

Any ball valve herein described, said spring being a bellows spring or being one or more Belleville spring(s).

Any valve herein described having a spring cavity filled with a spring and with filler between any spaces in said spring.

Any ball or other type valve herein described, said filler being braided graphite or braided graphite with an INCONEL® wire therein.

Any ball valve herein described, said ball valve being a coker ball valve.

Any ball valve herein described, and can be a two way valve, a three way valve, a 4-way valve, an isolation valve or a safety valve.

Any ball valve herein described, said spring cavity having an annular spring liner under said spring wherein said ball seat and said spring liner are a single integrated ball-seat-and-spring-liner component.

Any ball valve herein described, said ball seat having an annular groove on a housing body facing surface thereof, and a seal in said annular groove and adjacent said housing body. This “proximal” seal may be included on both ball seats.

Any ball valve herein described, further comprising a second annular seal at a distal end of said spring cavity opposite said ball seat. If the ball valve has two springs, it may be included at the distal end of each spring cavity.

Any ball valve herein described, wherein said ball seat further comprises an annular groove on an inner edge of said curved surface, and steam holes penetrating said ball seat from said spring-facing surface to said groove, such that purge fluid can directly reach an interface between said curved surface and said ball.

Any ball valve herein described, said ball valve being a coker ball valve and said filler being braided graphite. Where seals are included, they may also be a braided graphite.
A coker ball valve, having one or more spring(s) in a spring cavity, said spring(s) configured to press a ball seat against a rotatable ball having a hole therethrough, and a braided graphite filler within said spring cavity surrounding said spring to reduce empty space within said spring cavity, said spring having at least twice the lifespan of a spring in an identical or “control” coker ball valve that is otherwise the same, but lacking said filler. Ideally, the lifespan increases 5-fold or even 10-fold or more and this is easily achievable if more than one of the improvements described herein are included in the ball valve.
A component of a ball valve, said component comprising an integral spring-liner-and-ball-seat, said spring liner portion configured for supporting a separate annular spring configured to press said ball seat portion against a separate ball in said ball valve when assembled therewith.

Whether integral or not, the liner may have a groove circumnavigating its outer surface (outer diameter) so that a seal may be placed therein between the liner and the valve body. Of course, the groove could be in the body instead, but adding a groove to the liner is preferred as easier to manufacture and to retrofit. This seal is the same material as the filler and preferably is a similar graphite material in the coker environment.
A component of a ball valve, said component comprising an annular ball seat, said ball seat having an annular curved surface interfacing with a separate ball and an annular spring-facing surface opposite said curved surface, wherein said ball seat further comprises an annular groove on or near an inner edge of said curved surface, and steam holes penetrating said ball seat from said spring-facing surface to said groove, such that purge fluid can reach an interface between said curved surface and said ball.

A second groove can be included on the body side of the ball seat (outer diameter) so that a seal may be placed therein, the seal being the same material as the filler and preferably being a similar graphite material in the coker context. As with the distal seal, the groove could be in the body, or in both components, but machining the ball seat is easier and amenable to retrofitting.

As used herein, a “coker valve” is a valve specially built for the extreme conditions of a coker unit, and thus comprises highly durable materials for contact with corrosive and caustic materials and high cycling, extreme temperature changes. Coker valves are typically made from materials like A217 Gr. C12, A217 Gr. C5, INCOLOY® 800 H, and 317 stainless steel, which are chosen for their ability to withstand harsh conditions and thermal cycling in refinery environments. These materials help ensure durability and reliability in the coking process.

INCOLOY® refers to a range of superalloys now produced by the SPECIAL METALS CORPORATION (SMC) group of companies in 1952. INCOLOY® alloys belong to the category of super austenitic stainless steels and are mostly chromium-based and mostly nickel-based, and designed for corrosion resistance as well as strength at high temperatures. Further information on these various products can be found at en.wikipedia.org/wiki/Incoloy, or specialmetals.com/documents/technical-bulletins/incoloy/incoloy-alloy-800 h-800 ht.pdf, each incorporated by reference in its entirety for all purposes.

INCONAL® is another superalloy composed mainly of nickel, chromium, and iron by HUNTINGTON ALLOYS™ that is often used in extreme environments where components are subjected to high temperature, pressure, or mechanical loads. When heated, INCONAL® forms a thick, stable passivating oxide layer protecting the surface from further attack. INCONAL® retains strength over a wide temperature range, making it attractive for high-temperature applications in which aluminum and steel would succumb to creep. More information on these superalloys is found at seathertechnology.com/inconel-alloys/, incorporated by reference in its entirety for all purposes.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

The phrase “consisting of” is closed, and excludes all additional elements.

The phrase “consisting essentially of” excludes additional material elements, but allows the inclusions of non-material elements that do not substantially change the nature of the invention.

The following abbreviations are used herein:

| ABBREVIATION | TERM |
|---|---|
| AGO | atmospheric gas oil |
| DCU | delayed coker unit |
| VGO | vacuum gas oil |

### BRIEF DESCRIPTION OF THE DRAWINGS

FIG. 1. Prior art: Two piece body, trunnion mounted ball valve.

FIG. 2A. Prior art: shows a typical bellows spring.

FIG. 2B. Prior art: braided graphite.

FIG. 2C. Filler is fitted between corrugations on the inner and outer surface.

FIG. 3. A cross-section of a ball valve with filler wound around bellows.

FIG. 4A-C. A variety of Belleville spring arrangements with filler.

FIG. 5A. Prior art: an exploded view of a spring liner and seat which are two separate pieces allowing steam escape at their interface.

FIG. 5B. A single integral liner/seat combination preventing steam escape since there is no interface between these two components.

FIG. 5C. A cutaway perspective view of the integral liner/seat combination in a ball valve.

FIG. 6. A cutaway perspective view of a ball valve with an added second distal seal at the near end of the spring (opposite the ball seat).

FIG. 7A. Prior art: Typical ball seat with curved inner surface machined to fit tightly against ball.

FIG. 7B. Redesigned seat showing groove on the curved face (intermediate the edges) and steam holes in the groove allowing steam to reach curved surface and the ball.

FIG. 7C Redesigned seat showing groove on the curved face on the inner diameter and steam holes in the groove allowing steam to reach curved surface and the ball.

FIG. 7D. A cutaway perspective view of a ball valve with the new ball seat design of FIG. 7B.

FIG. 8A cross-sections of liner, and ball seat each with added grooves into which the extra seals can be fitted.

FIG. 8B cross-sections of integral liner-and-ball-seat with added grooves into which the extra seals can be fitted.

FIG. 9. A cutaway perspective view of a ball valve with each of the new features.

### DETAILED DESCRIPTION

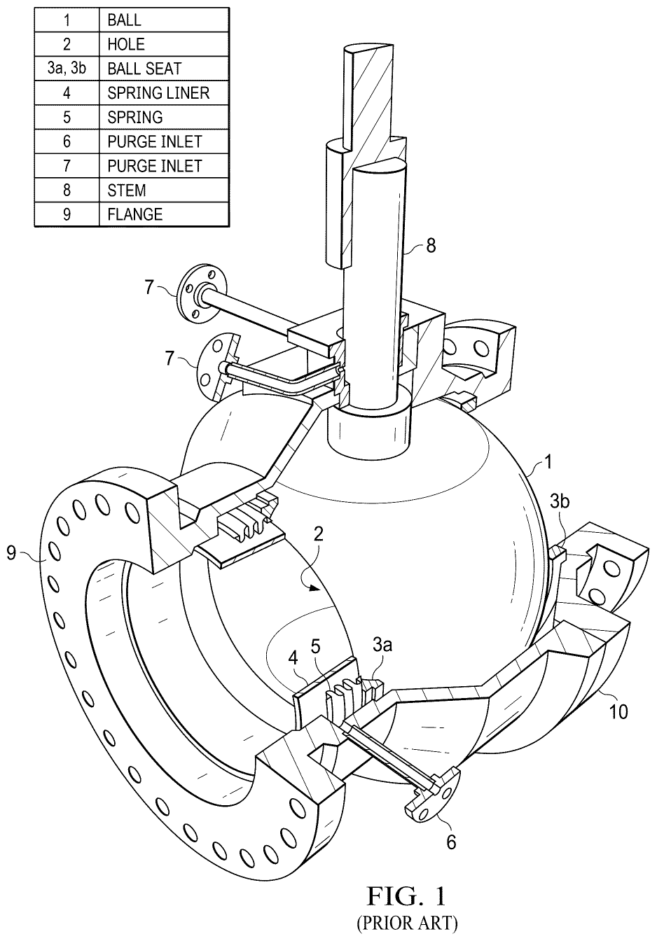

FIG. 1 depicts a cut away view of typical prior art two part ball valve. Seen are ball 1, hole 2, and body 10. Inside body 10 we have ball seats 3a and 3b, spring liner 4, bellows spring 5 and spring cavity purge inlet 6. As can be seen, the seats 3a-b, spring 5 and liner 4 are all annular, circumnavigating the flow path. The trunnion is not visible in this view, but sits under the ball, roughly mirroring the stem 8. Also seen are additional purge inlets 7 to the stem 8, as well as flanges 9 for connection to piping. The region of redesign herein encompasses elements 3-5.

Note, that this design has two ball seats, but single ball seat designs are also possible. In addition, the fluid pathway through the hole is the inner side, and the body side is considered outer, while the ball side is proximal and the side of the spring cavity opposite the ball is considered distal. Thus, the spring 5 sits on the outer diameter of the liner 4 and purge inlet 6 connects to the outer diameter of the spring cavity. It can't be seen in this view, but typically on the opposite side of the valve is a second purge inlet connecting with the inner diameter of the spring cavity.

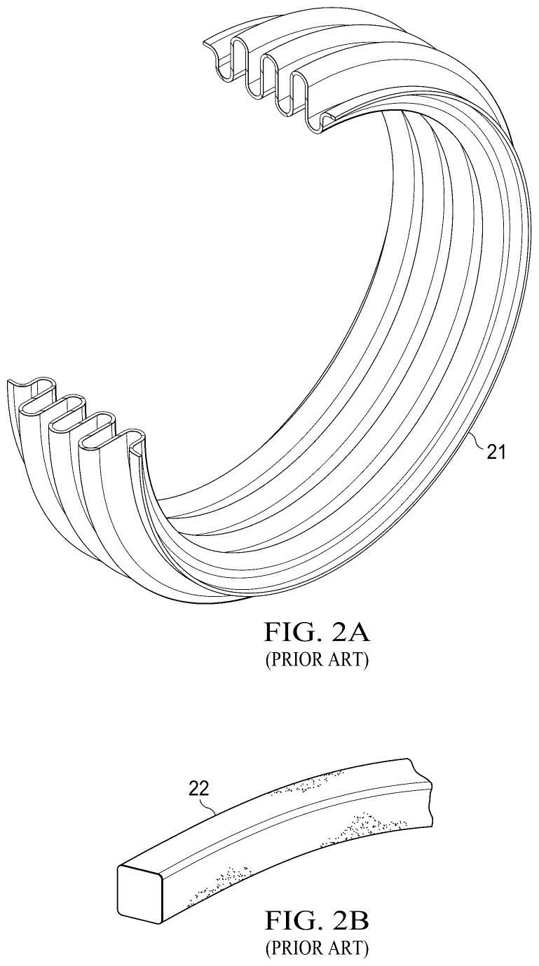

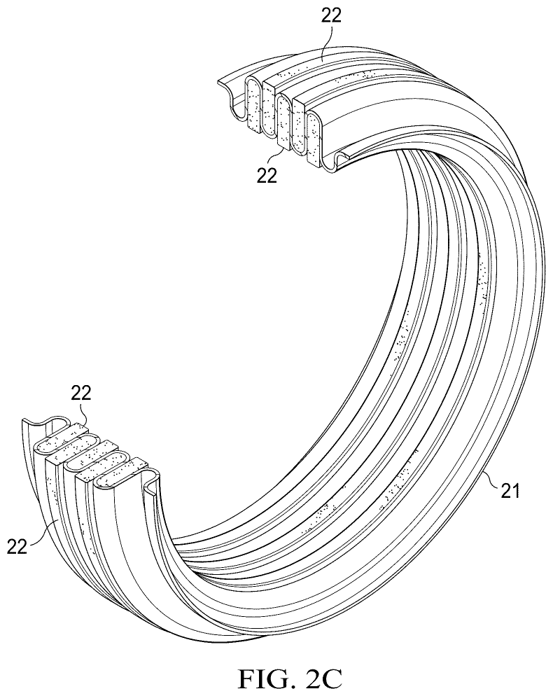

In FIG. 2A we see a typical bellows spring 21 and FIG. 2B shows a strand of braided graphite 22. In FIG. 2C the graphite filler 22 is wound around the bellows, fitting between raised corrugations on both inner and outer surfaces of bellow 21. This modification is simple to do whenever springs are being replaced, and no retrofitting of any other component is needed.

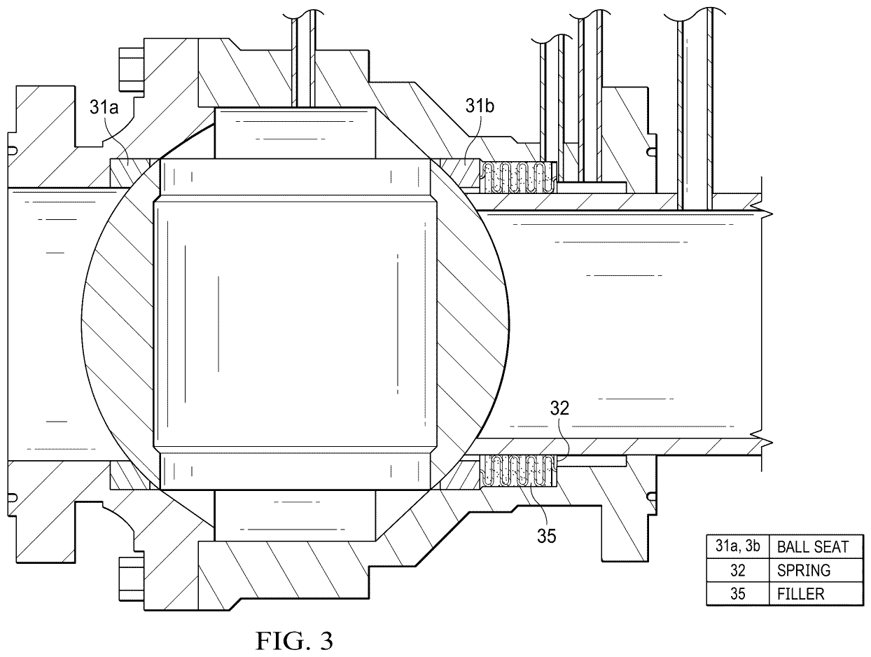

FIG. 3A is a cross section of a ball valve with ball seat 31a and 31b, bellow spring 35, and filler 32 filling the bellow corrugations inside and out.

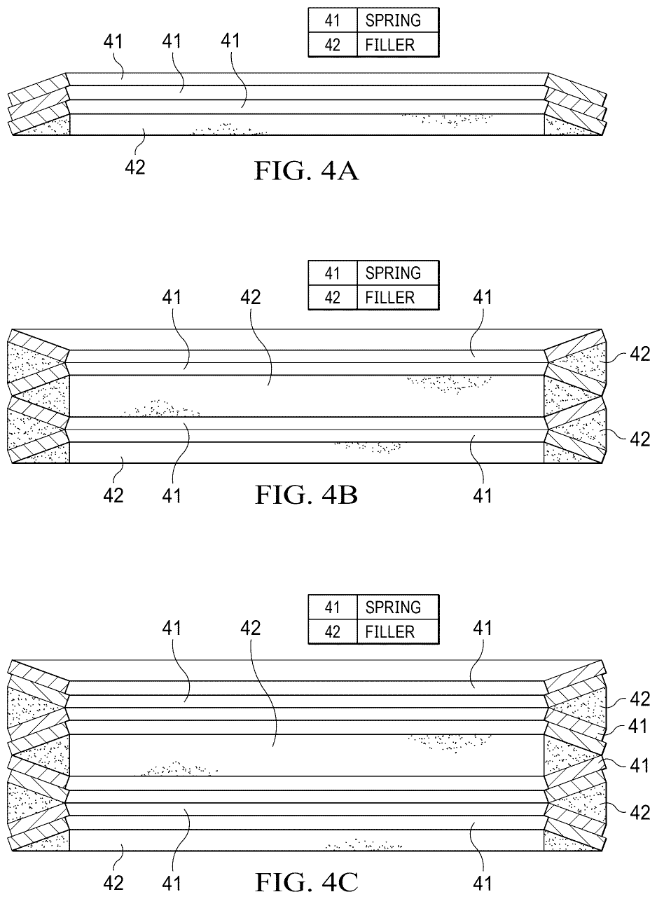

FIG. 4A-C show a variety of Belleville spring 41 arrangements, wherein filler 42 can be fitted in the available spaces therebetween. In FIG. 4A we see 3 stacked Belleville springs 41, in FIG. 4B there are 4 alternating springs 41, and in FIG. 4C there are 4 alternating pairs of stacked springs 41. All available space is filled with porous filler.

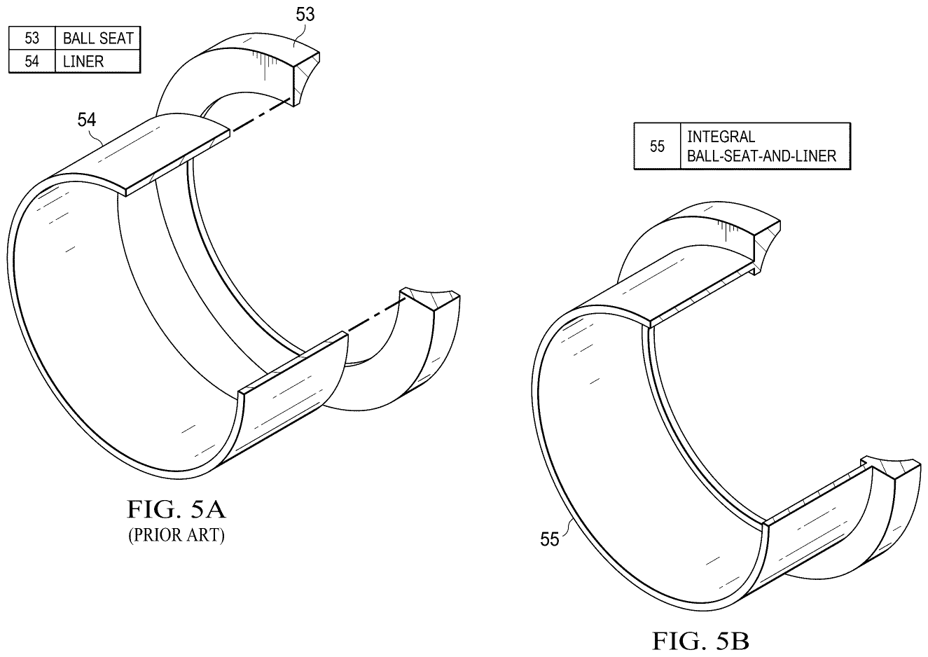

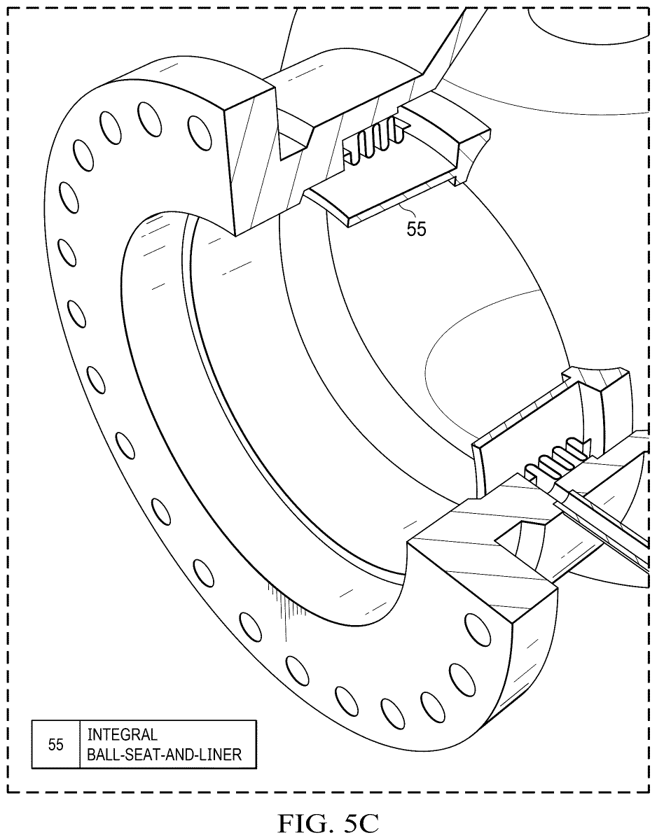

In FIG. 5A we see the spring liner 54 and the ball seat 53 are two separate pieces, allowing steam loss at the interface. In FIG. 5B they are a single integral liner/seat 55 combination, thus eliminated a source of steam loss. FIG. 5C shows the whole cutaway perspective with new integral piece 55.

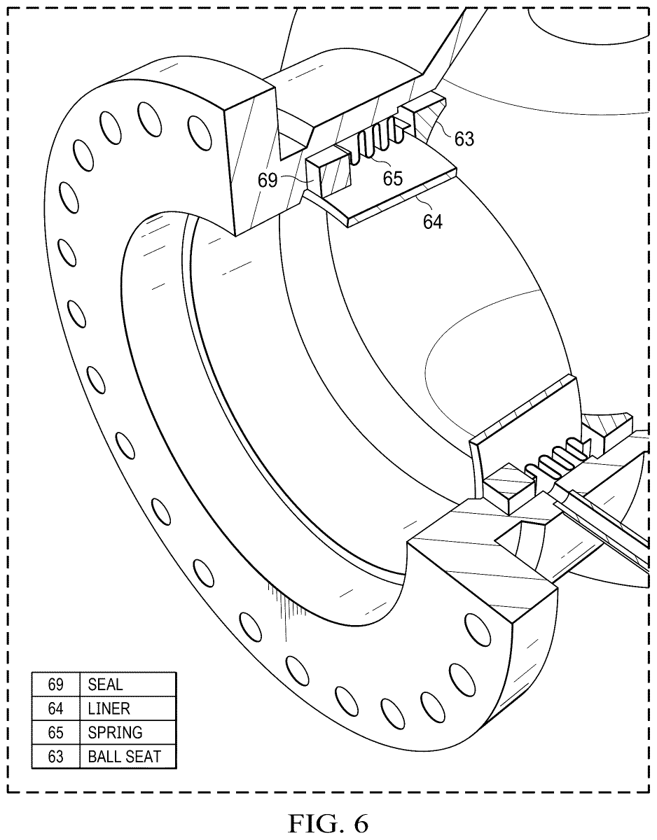

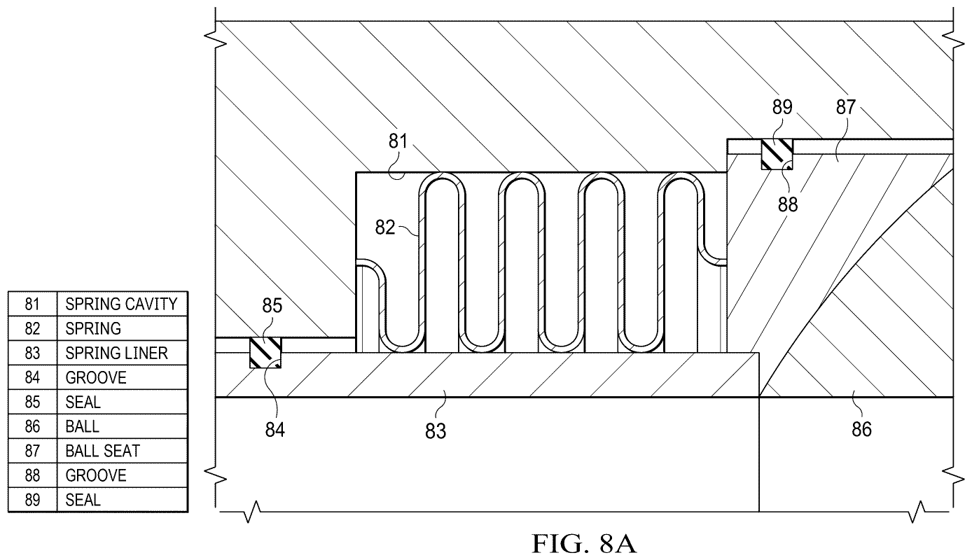

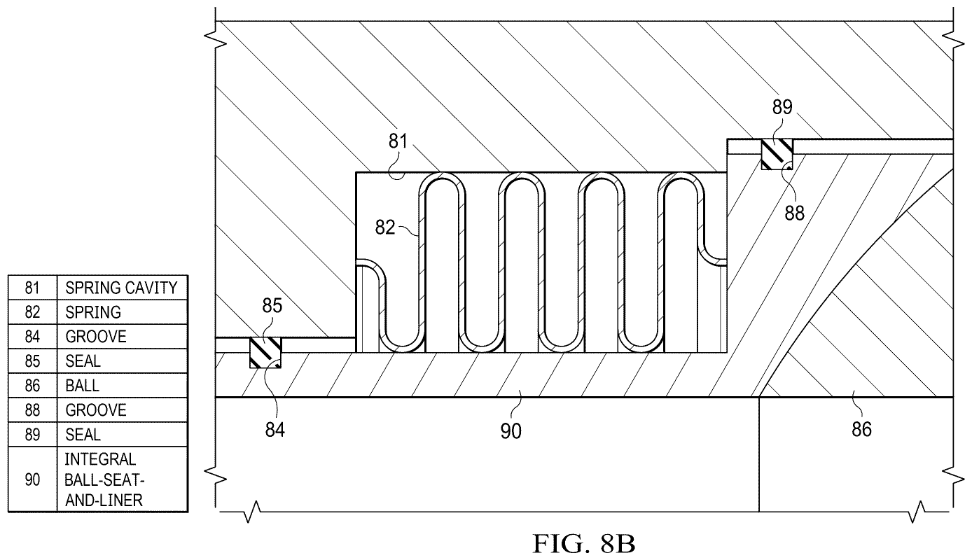

In FIG. 6 we see spring liner 64, ball seat 63, bellows spring 65 and added second distal seal 69 at the near end of the spring (away from the ball). The distal seal 69 is also annular creating a seal at the distal end of the spring that nonetheless allows for expansion under heat. To effectuate this improvement, the body itself may be modified to provide space for this second seal, however, it is preferred instead that the liner is machined to accommodate the seal, as shown in FIG. 8.

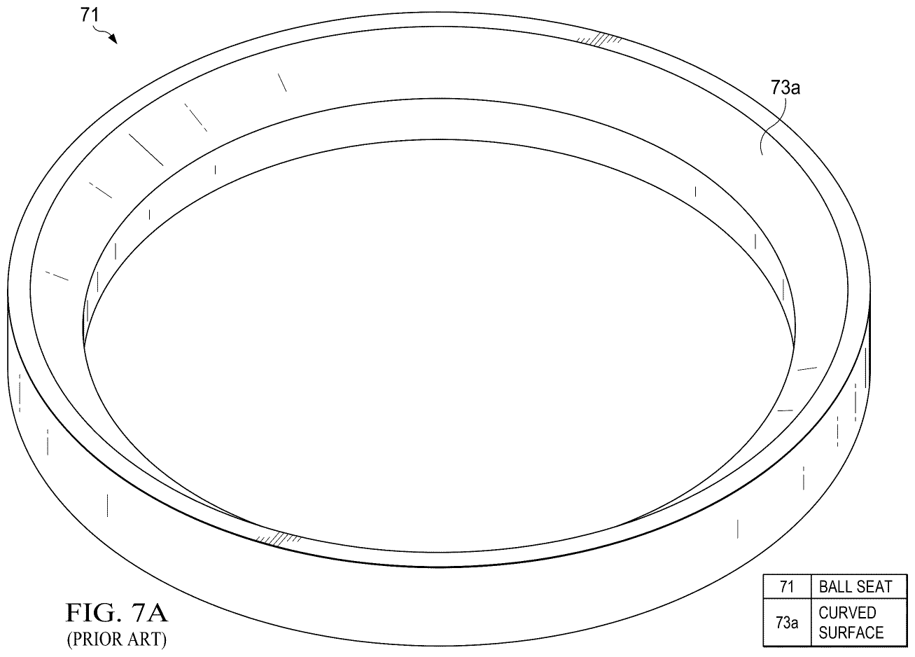

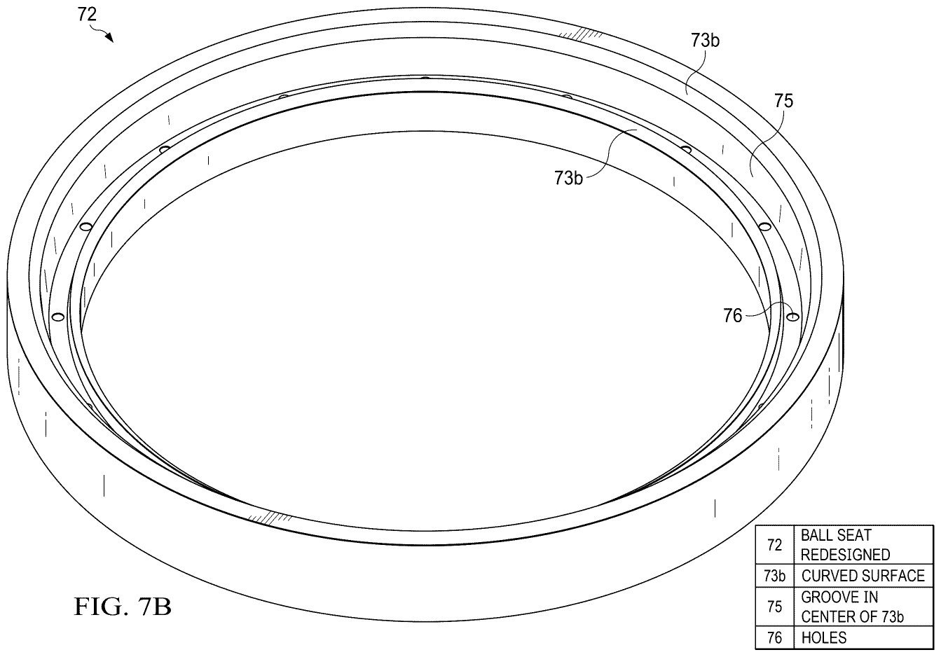

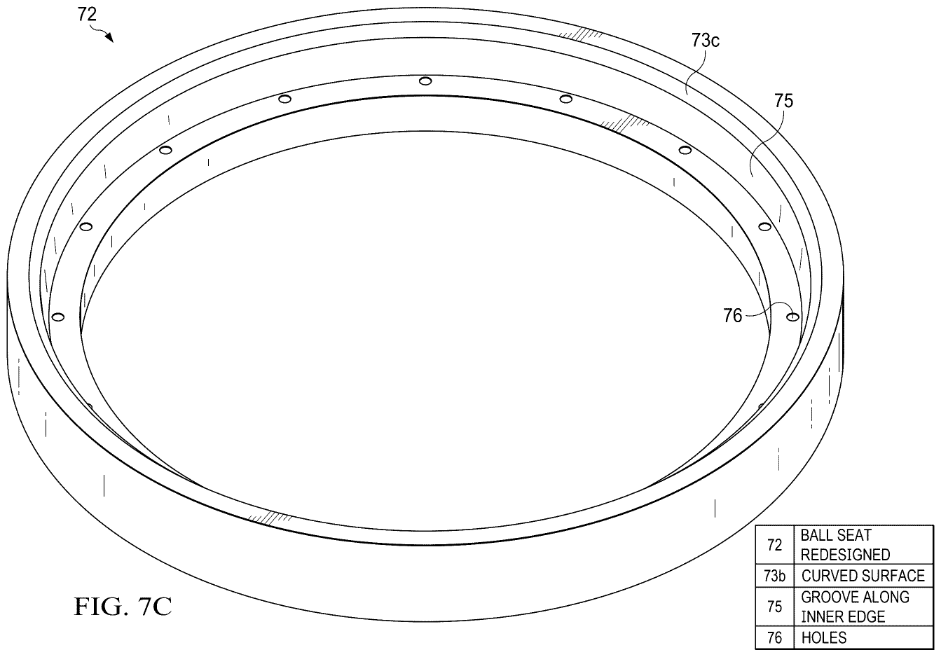

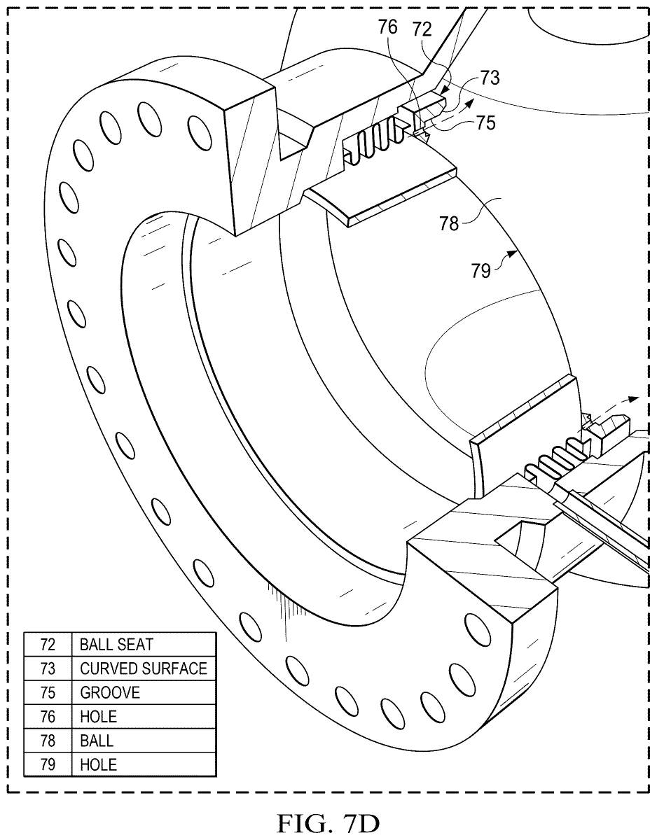

FIG. 7A is a typical prior art ball seat 71 with curved inner surface 73a machined to fit tightly against the ball, thus providing a seal. The exact shapes of other surfaces may vary depending on the valve body design and the need to fit other components, but the seat is basically an annular disc with curved ball surface.

In FIG. 7B we see the new ball seat design 72 with an added annular groove 75 near the hole or inner edge of the curved surface face 73b, thus splitting 73b into two sections. As can be seen, any groove reduces the width of the curved face, but the seat can be widened to accommodate the groove without sacrificing the curved interface, at least in larger valves. Steam holes 76 run from the spring-facing side of the ball seat to the groove, allowing steam to reach from the spring cavity to the interface between the curved surface 73b and the ball 79.

FIG. 7C shows a variation of this idea wherein the groove or ledge is adjacent the inner curved surface 73c, so only a single curved surface 73c remains. Regardless of exact position where engraved, injection of steam via holes 76 to the groove or ledge keeps process fluid out, even where a scratch, gall or spall has occurred, again increasing the lifespan of the ball valve.

FIG. 7D shows a cutaway perspective of the redesigned seat 72 assembled against the ball 79 as shown in FIG. 7B.

FIG. 8 shows the two added seals in the ball seat and liner and grooves that can be made to accommodate the new seals. Of course, the body itself could be grooved instead, but modifying the inner components is easier to both manufacture and to retrofit and is thus preferred.

In more detail, in FIG. 8A we see the spring cavity 81 in the body (not numbered or fully drawn, but see 10 in FIG. 1) that contains the spring 82, here a bellows spring that divides the spring cavity into outer and inner spaces. The springer liner 83 has a groove 84 that has been cut into the outer surface thereof, allowing the placement of seal 85 to seal off the distal end of the spring cavity 81. The ball seat 87 is pressed against ball 86 by spring 82 and it has a groove 88 on the outer diameter allowing placement of seal 89 thus sealing off the end of the spring cavity 81 that is proximal to the ball 86.

FIG. 8B is similar, but instead of separate liner 83 and ball seat 87, we have integral ball-and-liner 90 with the new seals 85 and 89.

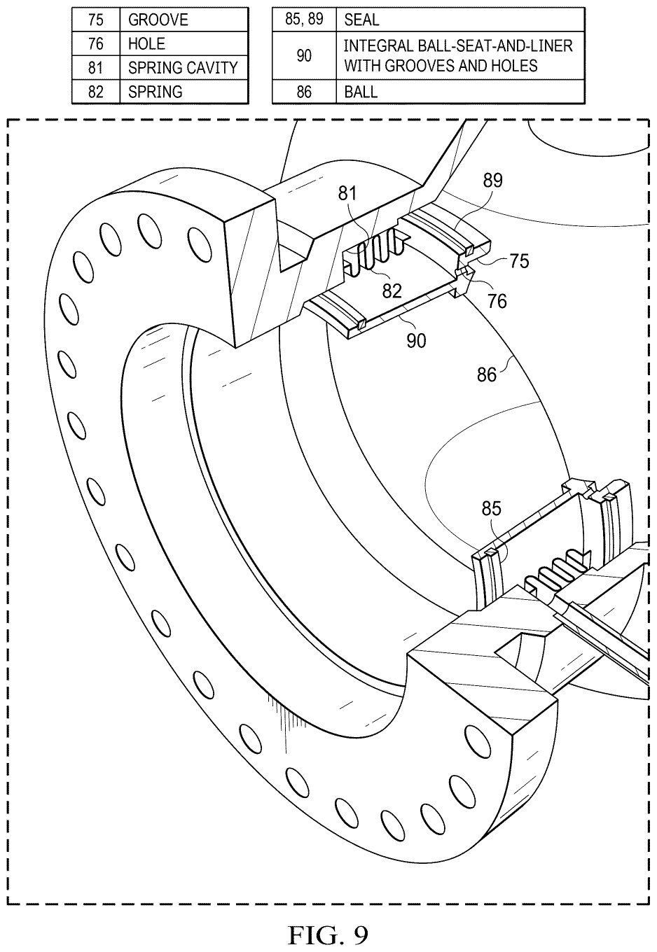

FIG. 9 shows a cut away perspective with the all the new design features together.

Using one or more of these new modifications to the spring cavity region of a ball valve provides increased lifespan of the component and of the spring cavity. Using all together is expected to greatly increase the lifespan of the spring, seat, ball and spring cavity.

The following references are incorporated by reference in their entirety for all purposes.
U.S. Pat. No. 12,331,848 Top entry valve for severe industrial applications
U.S. Pat. No. 10,400,900 Multi-port ball valve with induced flow in ball-body cavity
US20110233438 Ball valve sealing ring
U.S. Pat. No. 4,867,414 Ball valve
U.S. Pat. No. 4,579,316 Metal seated ball valves

1. A ball valve comprising:
a) a housing body having a flow path therethrough, said flow path containing a rotatable ball having a hole therethrough;
b) said ball adjacent a first annular ball seat, said ball seat having an annular curved surface interfacing with said ball to provide a seal and an annular spring-facing surface opposite said curved surface;
c) an annular spring cavity adjacent said first ball seat;
d) a second ball seat opposite said first ball seat;
e) one or more purge inlet(s) penetrating said housing body to said spring cavity;
f) said spring cavity housing an annular spring for biasing said ball seat against said ball so as to provide a seal between said curved surface and said ball; and
g) said spring cavity having a porous filler in space unoccupied by said spring.

2. The ball valve of claim 1, said spring being a bellows spring or one or more Belleville spring(s).

3. The ball valve of claim 1, said filler being braided graphite or braided graphite with a superalloy wire therein.

4. The ball valve of claim 1, said spring cavity having an annular spring liner under said spring, said spring liner having an annular groove on a spring cavity facing surface thereof, and a seal in said annular groove and adjacent said housing body.

5. The ball valve of claim 1, said ball seat having an annular groove on a housing body facing surface thereof, and a seal in said annular groove and adjacent said housing body.

6. The ball valve of claim 1, said spring cavity having an annular spring liner under said spring and said ball seat and said spring liner being a single integrated ball-seat-and-spring-liner component.

7. The ball valve of claim 1, wherein said ball seat further comprises an annular groove in said curved surface, and steam holes penetrating said ball seat from said spring-facing surface to said groove, such that purge fluid can reach an interface between said curved surface and said ball.

8. The ball valve of claim 1, said ball valve further comprising:
a) an annular spring liner supporting said annular spring, wherein said ball seat and said spring liner are a single integrated ball-seat-and-spring-liner having a spring-liner portion and a ball-seat portion;
b) said spring-liner portion having an annular groove on a spring cavity facing surface thereof, and a seal in said annular groove and adjacent said housing body;
c) an annular groove in said curved surface of said ball-seat portion, and steam holes penetrating said ball-seat portion from said spring-facing surface to said groove, such that a purge fluid can reach an interface between said curved surface and said ball; and
d) an annular groove on a housing body facing surface of said ball-seat portion, and a seal in said annular groove and adjacent said housing body.

9. The ball valve of claim 1, said ball valve being a coker ball valve and said filler and said seal (if present) being braided graphite.

10. A coker ball valve, having one or more spring(s) in a spring cavity, said spring(s) configured to press a ball seat against a rotatable ball having a hole therethrough, and a braided graphite filler within said spring cavity surrounding said spring to reduce empty space within said spring cavity, said spring having at least twice the lifespan of a spring in a control coker ball valve lacking said filler.

11. A component of a ball valve, said component comprising:
a) an integral spring-liner-and-ball-seat comprising a spring-liner portion and a ball-valve portion;
b) said spring-liner portion configured for supporting a separate annular spring configured to press said ball-seat portion against a separate ball in a separate ball valve when assembled therewith; and
c) said spring-liner portion having an annular groove on a spring cavity facing surface thereof, and a separate seal in said annular groove and adjacent a body of said separate ball valve when assembled therewith.

12. A component of a ball valve, said component comprising:
a) an integral spring-liner-and-ball-seat comprising a spring-liner portion and a ball-valve portion;
b) said spring-liner portion configured for supporting a separate annular spring configured to press said ball-seat portion against a separate ball in a separate ball valve when assembled therewith; and
c) said spring-liner portion having an annular groove on a spring cavity facing surface thereof, and a separate seal in said annular groove and adjacent a body of said separate ball valve when assembled therewith;
d) said ball-seat portion having an annular curved surface interfacing with said separate ball and an annular spring-facing surface opposite said curved surface;
e) wherein said ball-seat portion further comprises an annular groove in said curved surface, and holes penetrating said ball-seat portion from said spring-facing surface to said groove, such that a purge fluid can travel through said holes to reach an interface between said curved surface and said separate ball when said component is assembled therewith to make a ball valve with purge inlets; and
f) said ball-seat portion further comprising an annular groove on an outer diameter surface and a separate seal in said groove and adjacent said body of said separate ball valve when assembled therewith.
